(19) United States
(12) Patent Application Publication
(10) Pub. No.: US 2009/0190900 A1
(43) Pub. Date: Jul. 30, 2009

(54) IMAGE RECORDING APPARATUS AND METHOD

(75) Inventor: Woong-Hee Lee, Suwon-si (KR)

Correspondence Address: MCNEELY BODENDORF LLP, P.O. BOX 34175, WASHINGTON, DC, 20043, US

(73) Assignee: Samsung Electronics Co., Ltd., Suwon-si (KR)

(21) Appl. No.: 12/332,638

(22) Filed: Dec. 11, 2008

(30) Foreign Application Priority Data
Jan. 24, 2008 (KR) 2008-7681

(51) Int. Cl. H04N 5/00

(52) U.S. Cl. 386/126; 386/E05.068

(57) ABSTRACT

A image recording apparatus includes: an image input receiver receiving images; an encoder compressing the received images and generating stream data; one or more cell buffers buffering the stream data in units of cells; a data recorder recording cell data, which is buffered units of cells, on a disc; a decoder decoding the buffered cell data when a user selects a real-time image synthesis option; and an image synthesizer synthesizing a connecting part between a previous scene of images, which are received from the decoder, and a current scene of images, which are received from the image input receiver, with a target image and transmitting the result of synthesis to the encoder in order to create a fading effect between the previous and current scenes.

### CROSS-REFERENCE TO RELATED APPLICATION

This application claims the benefit of Korean Patent Application No. 2008-7681, filed on Jan. 24, 2008, in the Korean Intellectual Property Office, the disclosure of which is incorporated herein by reference in its entirety.

### BACKGROUND OF THE INVENTION

1. Field of the Invention

Aspects of the present invention relate to an image recording apparatus and method, and more particularly, to an image recording apparatus and method which can smoothly change discontinuous scenes of a moving image while recording the moving image.

2. Description of the Related Art

FIG. 1 shows an abrupt scene change in a moving image recorded according to a conventional image recording method.

Referring to FIG. 1, in the conventional image recording method, when a current scene B of images is recorded after a previous scene A of images is recorded and then image recording was temporarily stopped, an abrupt scene change occurs in connecting between the previous scene A and the current scene B.

Therefore, the recorded moving image is downloaded to a personal computer (PC), and the downloaded moving image is edited using an image editing program, so that the previous scene A can be smoothly changed to the current scene B. That is, as of now, there is no method which can smoothly change discontinuous scenes in real time while recording a moving image.

While a moving image is being recorded, it can be edited only in units of chapters. That is, a chapter of the moving image can be deleted, or different chapters of the moving image can be connected to each other. However, different contents cannot be smoothly connected to each other. In addition, if a disc does not allow a moving image recorded thereon to be modified, it is impossible to modify the recorded moving image.

Although some conventional camcorders can create a fading effect, they use a lens, to which an image is input instead of software, to create the fading effect. In addition, a method used here applies a simple fading technique to a first image of a current scene instead of overlapping a last image of a previous scene with the first image of the current scene.

In this regard, a technology, which can smoothly change scenes in real time according to a scene-change option selected by a user while recording a moving image and thus enables the user to easily create various contents, is required.

### SUMMARY OF THE INVENTION

Aspects of the present invention provide an image recording apparatus and method which can smoothly change discontinuous scenes of a moving image while recording the moving image.

However, aspects of the present invention are not restricted to what is set forth herein. The above and other aspects of the present invention will become more apparent to one of ordinary skill in the art to which the present invention pertains by referencing the detailed description of aspects of the present invention given below.

According to an aspect of the present invention, there is provided an image recording apparatus to record on a disc, that includes an image input receiver receiving images, an encoder compressing the received images and generating stream data, one or more cell buffers buffering the stream data in units of cells, a data recorder recording cell data, which is buffered in units of cells, on the disc, a decoder decoding the buffered cell data when a user selects a real-time image synthesis option, and an image synthesizer unit synthesizing a connecting part between a previous scene of images, which is received from the decoder, and a current scene of images, which is received from the image input receiver, with a target image or graphic image, which is received from the graphic buffer and transmitting the result of synthesis to the encoder in order to create a fading effect between the previous and current scenes.

According to another aspect of the present invention, there is provided an image recording method involving encoding input images and generating stream data, buffering the stream data in units of cells to produce cell data, decoding cell data when a user selects a real-time image synthesis option, the user selecting a target image to be synthesized, synthesizing a connecting part between a previous scene of images, which is obtained after the cell data is decoded, and a current scene of images, which is input, with the target image in order to create a fading effect between the previous scene and the current scene, and encoding and then buffering in cells the result of synthesis and recording the result of the encoding on a disc.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows an abrupt scene change in a moving image recorded according to a conventional image recording method;

FIGS. 2 through 4 show a scene change in a moving image recorded by an image recording apparatus according to an exemplary embodiment of the present invention;

FIG. 5 is a block diagram of the image recording apparatus according to the exemplary embodiment of the present invention; and

FIG. 6 is a flowchart illustrating an image recording method according to an exemplary embodiment of the present invention.

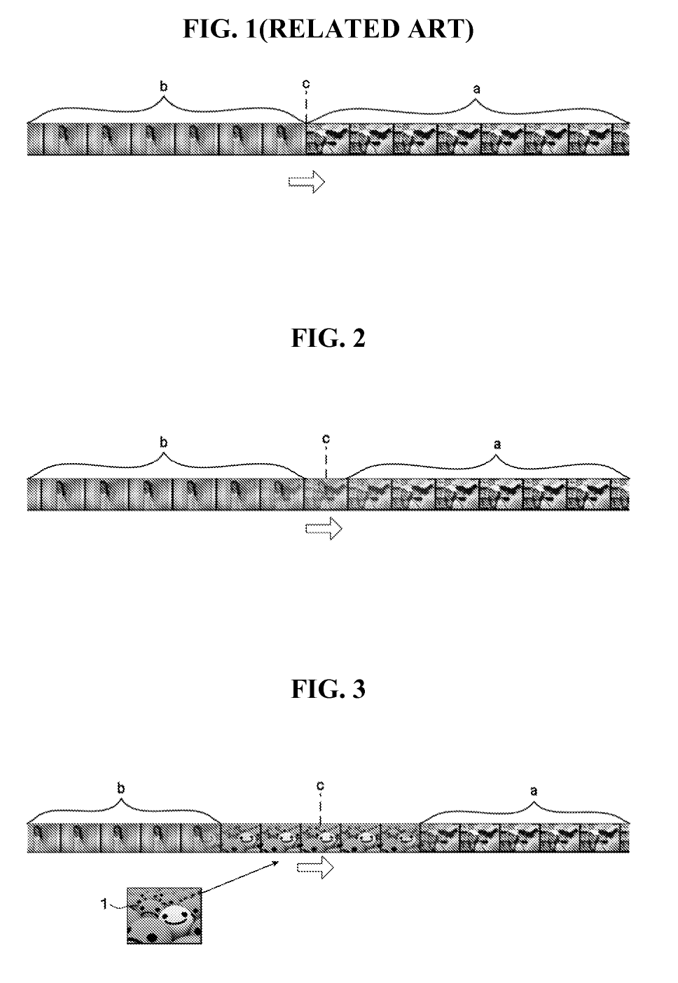

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, an image recording apparatus and method according to exemplary embodiments of the present invention will be described with reference to the attached drawings. A detailed description might be omitted when it is determined that related prior art or the detailed description of the structure may unnecessarily obscure the point of aspects of the present invention.

FIGS. 2 through 4 show a scene change in a moving image recorded by an image recording apparatus according to an exemplary embodiment of the present invention. FIG. 5 is a block diagram of the image recording apparatus according to the exemplary embodiment of the present invention.

Referring to FIG. 5, the image recording apparatus according to the present embodiment includes an image input receiver 10, an encoder, a muxer 30, one or more cell buffers 40, a data recorder 50, a decoder 60, an image synthesizer 70, and a graphic buffer 80.

The image input receiver 10 receives images of subjects. Although not shown in FIG. 5, the image input receiver 10 may include a lens, an iris diaphragm, and a charge-coupled device (CCD) sensor detecting images that passed through the lens and the iris diaphragm. The encoder 20 compresses the images received from the image input unit 10 by using a codec and generates stream data. The muxer 30 muxes the images compressed by the encoder 20 with audio and generates a system layer. The cell buffers 40 buffer the stream data, which was generated by the encoder 20 and the muxer 30, in units of cells. The data recorder 50 records cell data, which is buffered in the cell buffers 40, in a disc D such as a digital versatile/video disc (DVD).

When a user selects a real-time image synthesis option, the decoder 60 decodes the cell data buffered in the cell buffers 40. The image synthesizer 70 synthesizes a connecting part C between a previous scene A of images, which is received from the decoder 60, and a current scene B of images, which is received from the image input receiver 10, with a target image and transmits the result of synthesis to the encoder 20 in order to create a fading effect between the scenes A and B.

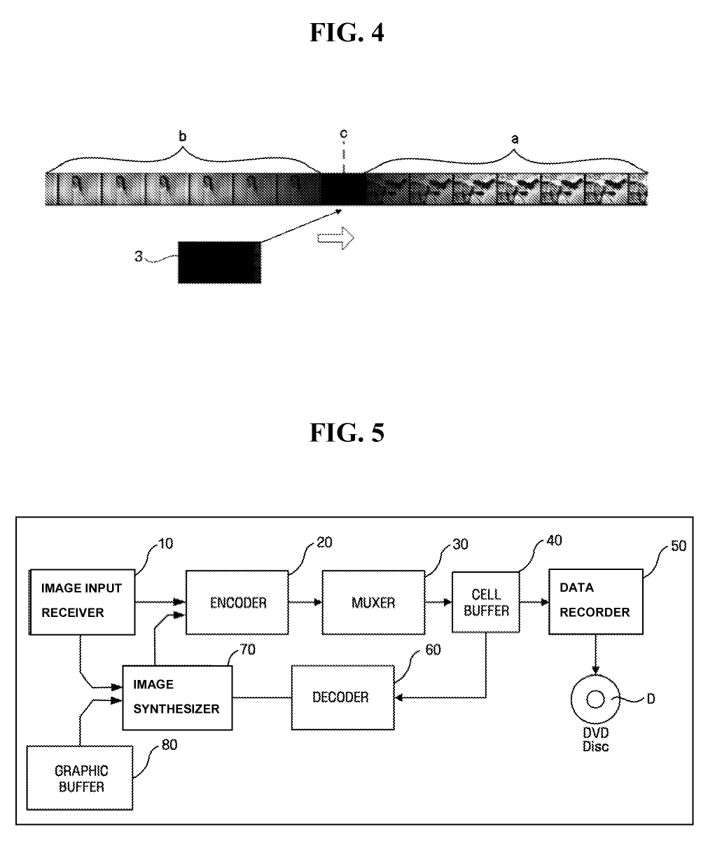

Specifically, the image synthesizer 70 may create a smooth fading effect between the scenes A and B by overlapping a last image of the previous scene A with a first image of the current scene B in the connecting part C between the previous scene A and the current scene B, as shown in FIG. 2, or by inserting a graphic image 1 or a color image 3 into the connecting part C between the previous scene A and the current scene B, as shown in FIGS. 3 and 4, respectively. When the user selects an option to synthesize the graphic image 1 or the color image 3 with the connecting part C, the graphic buffer 80 stores data on the graphic image 1 or the color image 3 that is used.

Hereinafter, an image recording method according to an exemplary embodiment of the present invention will be described in detail.

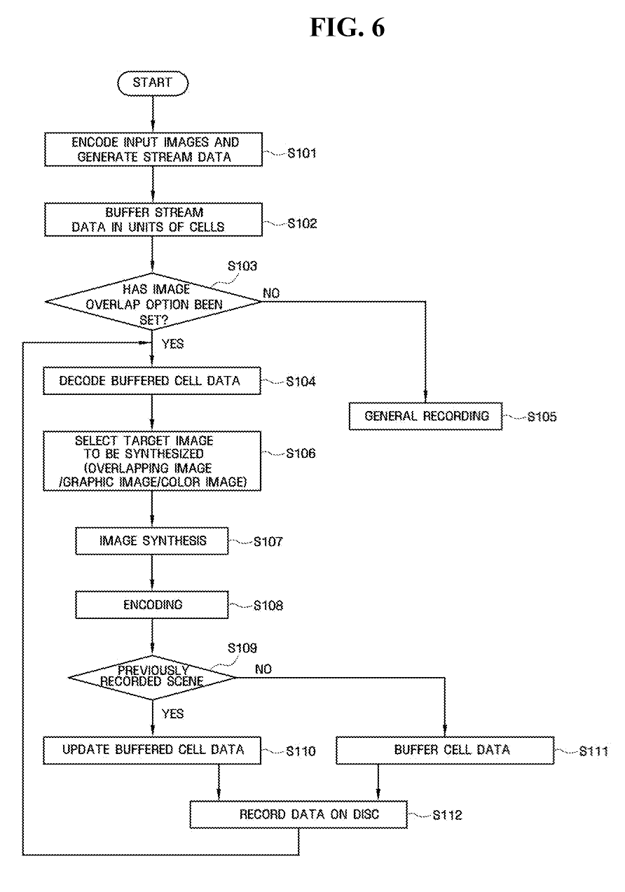

FIG. 6 is a flowchart illustrating an image recording method according to an exemplary embodiment of the present invention.

Referring to FIG. 6, images are input to the image input receiver 10 via the lens and the iris diaphragm, and the encoder 20 compresses the input images using a codec and generates stream data (operation S101). Here, the muxer 30 muxes the images compressed by the encoder 20 with audio and generates a stream layer.

Next, the cell buffers 40 buffer the stream data in units of cells in order to generate a navigation pack in the case of a DVD. When the buffered cell data is ready, the data recorder 50 records the buffered cell data on the disc D such as a DVD.

When a user sets an image overlap option (operation S103), the decoder 60 decodes the cell data that is buffered in each cell (operation S104). Here, the decoder 60 decodes the buffered cell data on a frame-by-frame basis to reduce the number of cell buffers 40 used. When the user does not set the image overlap option, general image recording is performed (operation 105).

Next, the user selects a target image to be synthesized (operation S106). For example, the target image may be an overlapping image of the last image of the previous scene A and the first image of the current scene B, the graphic image 1, or the color image 3 which is inserted into the connecting part C between the previous scene A and the current scene B in order to create a fading effect between the scenes A and B.

The image synthesizer 70 synthesizes the selected target image with the connecting part C between the previous scene A of the images, which is received from the decoder 60, and the current scene B of the images, which is received from the image input unit 10, in order to create a fading effect between the scenes A and B (operation S107). For example, the image synthesizer 70 may create a smooth fading effect between the scenes A and B by overlapping the last image of the previous scene A with the first image of the current scene B in the connecting part C between the previous scene A and the current scene B, as shown in FIG. 2, or by inserting the graphic image 1 or the color image 3 into the connecting part C between the previous scene A and the current scene B, as shown in FIGS. 3 and 4, respectively. If the graphic image 1 is inserted into the connecting part C, image chapter information regarding a corresponding chapter of the moving image, such as the time when a moving image was recorded, the place where the moving image was recorded and/or the title of the moving image of the chapter, may be provided in the graphic image 1.

For image synthesis, the image synthesizer 70 may alpha-blend the selected target image with the connecting part C by controlling the degree of image synthesis, which varies according to time, using weights. Alpha blending is an image processing method in which two images are overlaid on each other in a rendering process and output accordingly. Since alpha blending is a well-known technology, a detailed description thereof will be omitted.

Next, the image synthesizer 70 transmits the result of synthesis to the encoder 20, and the encoder 20 encodes the result of synthesis (operation S108). Then, it is determined whether the result of encoding is a previously recorded scene (operation S109). If it is determined that the result of encoding is the previously recorded scene, previously buffered cell data is updated (operation S110). If it is determined that the result of encoding is not the previously recorded scene, cell data of the result of encoding is buffered (operation S111). When the buffered cell data is ready, the data recorder 50 records the buffered cell data on the disc D, such as a DVD, a Blue-ray disc (BD), a high-definition DVD (HD-DVD), or other similar recording media (operation S112).

The image recording apparatus and method according to aspects of the present invention can be applied to disc-based camcorders and hybrid camcorders, such as DVDs, BDs and HD-DVDs, and DVD recorders. It is understood that the image recording method and apparatus can be applied to other image recording apparatuses and devices such as digital cameras, mobile phones and camera phones, personal computers, laptop computers and other devices which feature a video image recording capability.

As described above, an image recording apparatus and method according to aspects of the present invention provide at least one of the following advantages. First, a smooth fading effect can be created between discontinuous scenes of a moving image, which is being recorded, by overlapping a last image of each scene with a first image of a subsequent scene or by inserting a graphic image or a color image into each connecting part between the discontinuous scenes. Second, a function for smoothly changing scenes in real time while recording a moving image is provided. Therefore, when using a camcorder having this editing function, a user can create various contents. Third, since buffered cell data is decoded, the number of buffers required for image synthesis can be reduced.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image recording apparatus to record on a disc comprising:
an image input receiver receiving images;
an encoder compressing the received images and generating stream data;
one or more cell buffers buffering the stream data in units of cells;
a data recorder recording cell data, which is buffered units of cells, on the disc;
a decoder decoding the buffered cell data when a user selects a real-time image synthesis option; and
an image synthesizer synthesizing a connecting part between a previous scene of images, which is received from the decoder, and a current scene of images, which is received from the image input receiver, with a target image and transmitting the result of synthesis to the encoder to create a fading effect between the previous and current scenes.

2. The apparatus of claim 1, wherein the image synthesizer creates the fading effect between the previous and current scenes by overlapping a last image of the previous scene with a first image of the current scene in the connecting part between the previous scene and the current scene.

3. The apparatus of claim 1, wherein the image synthesizer creates the fading effect between the previous and current scenes by inserting a graphic image or a color image into the connecting part between the previous scene and the current scene.

4. The apparatus of claim 3, wherein the graphic image comprises chapter information regarding a corresponding chapter of a moving image being recorded.

5. The apparatus of claim 4, wherein the image chapter information comprises at least one of a time when a moving image was recorded, a place where the moving image was recorded, and title of the moving image.

6. The apparatus of claim 3, further comprising a graphic buffer storing data on the graphic image or the color image.

7. The apparatus of claim 1, wherein the image synthesizer alpha-blends the connecting part by controlling a degree of image synthesis, which varies according to time, using weights.

8. The apparatus of claim 1, further comprising a muxer muxing the images compressed by the encoder with audio.

9. An image recording method comprising:
encoding input images and generating stream data;
buffering the stream data in units of cells to produce cell data;
decoding the cell data, when a user selects a real-time image synthesis option;
selecting, by a user, a target image to be synthesized;
synthesizing a connecting part between a previous scene of images, which is obtained after the cell data is decoded, and a current scene of images, which is input, with the target image to create a fading effect between the previous scene and the current scene; and
encoding a result of the synthesis and recording the result of the encoding on a disc.

10. The method of claim 9, wherein the decoding of the cell data comprises the cell data is decoded on a frame-by-frame basis to reduce the number of cell buffers that are used.

11. The method of claim 9, wherein the target image is an overlapping image of a last image of the previous scene and a first image of the current scene, a graphic image, or a color image which is inserted into the connecting part between the previous scene and the current scene to create the fading effect between the previous and current scenes.

12. The method of claim 9, wherein the synthesizing of the connecting part comprises alpha-blending the connecting part with the target image by controlling a degree of image synthesis, which varies according to time, using weights.

13. The method of claim 9, wherein the encoding of the result of the synthesis comprises:
determining whether the result of encoding is a previously recorded scene;
updating previously buffered cell data if determined that the result of encoding is the previously recorded scene and buffering the cell data if determined that the result of encoding is not the previously recorded scene; and
recording the buffered cell data on the disc.

14. A method of real-time recording of discontinuous image scenes on an image recording device, comprising:
recording a first recorded image scene and stopping the recording;
starting a recording of a currently recording image scene; and
changing smoothly in real-time between the first recorded image scene and the currently recording image scene.

15. The method of claim 14, wherein the changing smoothly in real-time comprises inserting a target image between the first recorded image scene and the currently recording image scene, wherein the target image comprises one of a first image of the currently recording image scene, a graphic image, an alpha-blending of a last image of the first recorded image scene and the first image of the currently recording image scene, or a color image.

16. The method of claim 15, wherein the recording of the first recorded image scene comprises:
receiving the first recorded image scene;
encoding the first recorded image scene into first encoded stream data;
muxing the first encoded stream data with audio; and
buffering the first encoded stream data into units of cells.

17. The method of claim 16, further comprising enabling selection between a selectable image overlap option and a general recording option, wherein:
if the general recording option is selected, the changing smoothly in real time comprises:
receiving the currently recording image scene;
encoding the currently recording image scene into currently encoded stream data;
muxing the currently encoded stream data with audio;
buffering the currently encoded stream data into units of cells; and
recording the buffered first encoded stream data and buffered currently encoded stream data.

18. The method of claim 16, further comprising enabling selection between a selectable image overlap option and a general recording option, wherein:
if the image overlap option is selected, the changing smoothly in real-time comprises:
decoding the buffered first encoded stream data;
selecting the target image from the first recorded image scene;
synthesizing into a synthesized image scene the last image of the first recorded image scene with the selected target image and the first image of the currently recording image scene;
encoding the synthesized image scene into synthesized encoded stream data;
muxing the synthesized encoded stream data with audio;
buffering the synthesized encoded stream data into units of cells; and
recording the buffered first encoded stream data and the buffered synthesized encoded stream data.

19. An image recording apparatus to record on a disc in real-time discontinuous image scenes, comprising:
an image input receiver receiving images in real-time;
an encoder compressing the received images and generating stream data;
one or more cell buffers buffering the stream data in units of cells;
a data recorder recording cell data, which is buffered units of cells, on the disc; and
a real-time discontinuous image synthesizer, with a user input device enabling a user to select between a real-time image synthesis option and a general recording option, synthesizing in real-time discontinuous image scenes.

20. The apparatus of claim 19, wherein the real-time discontinuous image synthesizer comprises:
a decoder decoding the buffered cell data when a user selects the real-time image synthesis option; and
an image synthesizer smoothly changing in real-time between a connecting part of a first scene of images, which is received from the decoder, and a current scene of images, which is received from the image input receiver, and a target image and transmitting the result of synthesis to the encoder to create a fading effect between the first and current scenes.

21. The apparatus of claim 20, wherein the image synthesizer creates the fading effect between the first and current scenes by smoothly changing in real-time between a last image of the first scene and a first image of the current scene in the connecting part between the first scene and the current scene.

22. The apparatus of claim 20, wherein the image synthesizer creates the fading effect between the first and current scenes by smoothly inserting in real-time a graphic image or a color image into the connecting part between the first scene and the current scene.

23. The apparatus of claim 22, wherein the graphic image comprises chapter information regarding a corresponding chapter of a moving image being recorded.

24. The apparatus of claim 23, wherein the image chapter information comprises at least one of a time when a moving image was recorded, a place where the moving image was recorded, and title of the moving image.

25. The apparatus of claim 22, further comprising a graphic buffer storing data on the graphic image or the color image.

26. The apparatus of claim 20, wherein the image synthesizer alpha-blends the connecting part by controlling a degree of image synthesis, which varies according to time, using weights.

27. The apparatus of claim 19, further comprising a muxer muxing the images compressed by the encoder with audio.
